(19) United States
(12) Patent Application Publication
(10) Pub. No.: US 2023/0297752 A1
(43) Pub. Date: Sep. 21, 2023

(54) INTEGRATED CIRCUITS INCLUDING ABUTTED BLOCKS AND METHODS OF DESIGNING LAYOUTS OF THE INTEGRATED CIRCUITS

(71) Applicant: Samsung Electronics Co., Ltd., Suwon-si (KR)

(72) Inventors: Jungho Do, Hwaseong-si (KR); Jisu Yu, Seoul (KR); Hyeongyu You, Hwaseong-si (KR); Minjae Jeong, Hwaseong-si (KR); Sanghoon Baek, Seoul (KR)

(21) Appl. No.: 18/162,120

(22) Filed: Jan. 31, 2023

(30) Foreign Application Priority Data
Mar. 16, 2022 (KR) 10-2022-0032946

(51) Int. Cl. G06F 30/392

(52) U.S. Cl. CPC G06F 30/392

(57) ABSTRACT

Integrated circuits including abutted blocks and methods of designing layouts of the integrated circuits are disclosed. The integrated circuit includes a first block having a first function cell array therein, which is at least partially surrounded by a first plurality of finishing cells, and a second block extending adjacent the first block. The second block includes a second function cell array therein, which is at least partially surrounded by a second plurality of finishing cells. The first plurality of finishing cells include: (i) a first finishing cell placed at a boundary of the integrated circuit, and (ii) a second finishing cell different from the first finishing cell, which is placed at a boundary between the first block and the second block.

### REFERENCE TO PRIORITY APPLICATION

This application claims priority under 35 U.S.C. § 119 to Korean Patent Application No. 10-2022-0032946, filed Mar. 16, 2022, the disclosure of which is hereby incorporated herein by reference.

### BACKGROUND

The inventive concept relates to an integrated circuit and, more particularly, to an integrated circuit including abutted blocks therein, and methods of designing a layout of the integrated circuit.

According to the development of semiconductor processes, the sizes of devices may decrease, and the number of devices included in an integrated circuit may increase. An integrated circuit may include blocks respectively providing various functions, and the blocks may be independently designed. Each of the blocks may be designed to meet various requirements according to the complexity of a semiconductor process. Unfortunately, blocks designed independently of each other may often be inefficiently placed in the integrated circuit.

### SUMMARY

The inventive concept provides an integrated circuit, in which blocks designed independently of each other are optimally placed, and a method of designing the integrated circuit.

According to an aspect of the inventive concept, there is provided a method of designing an integrated circuit, which includes placing a first block including a first function cell array into a layout of the integrated circuit, and placing a second block including a second function cell array into the layout of the integrated circuit, such that the second block extends adjacent the first block within the layout. Advantageously, the first block includes first finishing cells that extend along a boundary of the first block, and the second block includes second finishing cells that extend along a boundary of the second block. In addition, at least some of the first finishing cells abut at least some of the second finishing cells within the layout, at a boundary between the first and second blocks.

According to another aspect of the inventive concept, a method of designing an integrated circuit is provided, which includes placing a first block including a first function cell array into a layout of the integrated circuit, and placing a second block including a second function cell array into the layout of the integrated circuit, such that the second block extends adjacent the first block within the layout. The placing a second block includes securing a dummy region between the first block and the second block, such that the second block abuts the dummy region.

According to another aspect of the inventive concept, an integrated circuit is provided, which includes a first block having a first function cell array therein, which is at least partially surrounded by a first plurality of finishing cells, and a second block extending adjacent the first block. The second block includes a second function cell array therein, which is at least partially surrounded by a second plurality of finishing cells. In some of these embodiments, the first plurality of finishing cells include: (i) a first finishing cell placed at a boundary of the integrated circuit, and (ii) a second finishing cell different from the first finishing cell, which is placed at a boundary between the first block and the second block.

### BRIEF DESCRIPTION OF THE DRAWINGS

Embodiments of the inventive concept will be more clearly understood from the following detailed description taken in conjunction with the accompanying drawings in which:

FIG. 1 is a plan view illustrating a layout of an integrated circuit according to an example embodiment;

FIG. 2 is a flowchart illustrating a method of designing an integrated circuit, according to an example embodiment;

FIG. 3 is a plan view illustrating a layout of an integrated circuit, according to an example embodiment;

FIG. 4 is a flowchart illustrating a method of designing an integrated circuit, according to an example embodiment;

FIG. 5 is a flowchart illustrating a method of designing an integrated circuit, according to an example embodiment;

FIGS. 6A and 6B are diagrams illustrating block boundaries according to example embodiments;

FIG. 7 illustrates examples of a transition cell according to an example embodiment;

FIGS. 8A and 8B illustrate examples of a transition cell, according to example embodiments;

FIG. 9 is a plan view illustrating a layout of an integrated circuit, according to an example embodiment;

FIGS. 10A through 10C are diagrams illustrating examples of finishing cells, according to example embodiments;

FIG. 11 is a plan view illustrating a block according to an example embodiment;

FIG. 12 is a flowchart illustrating a method of designing an integrated circuit, according to an example embodiment;

FIG. 13 is a plan view illustrating a layout of an integrated circuit, according to an example embodiment;

FIG. 14 is a plan view illustrating a layout of an integrated circuit, according to an example embodiment;

FIG. 15 is a flowchart illustrating a method of designing an integrated circuit, according to an example embodiment;

FIG. 16 is a flowchart illustrating a method of designing an integrated circuit, according to an example embodiment;

FIG. 17 is a diagram illustrating block boundaries, according to an example embodiment;

FIG. 18 is a flowchart illustrating a method of manufacturing an integrated circuit, according to an example embodiment;

FIG. 19 is a block diagram illustrating a system on chip (SoC) according to an example embodiment; and

FIG. 20 is a block diagram illustrating a computing system including a memory for storing a program, according to an example embodiment.

### DETAILED DESCRIPTION OF THE EMBODIMENTS

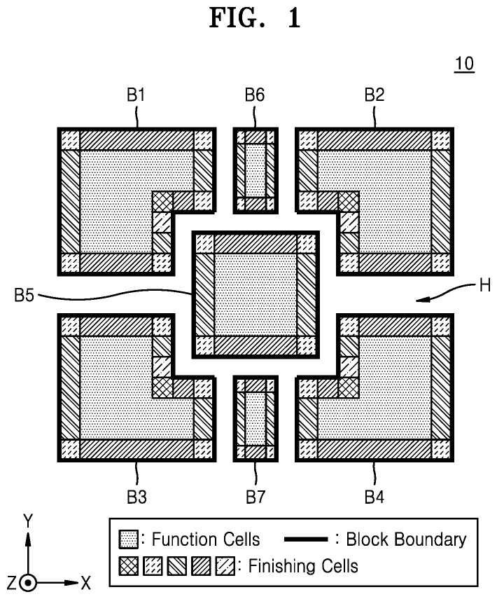

FIG. 1 is a plan view illustrating a layout of an integrated circuit 10, according to an example embodiment. The integrated circuit 10 may be manufactured using a semiconductor process, and may include a plurality of blocks designed independently of each other. For example, as illustrated in FIG. 1, the integrated circuit 10 may include first through seventh blocks B1 through B7, and the first through seventh blocks B1 through B7 may be independently designed.

Herein, an X-axis direction and a Y-axis direction may be referred to as a first direction and a second direction, respectively, and a Z-axis direction may be referred to as a third direction or a vertical direction. A plane formed by an X-axis and a Y-axis may be referred to as a horizontal plane, a component placed in a +Z-axis direction relative to other component may be referred to as being above the other component, and a component placed in a −Z-axis direction relative to other component may be referred to as being under the other component. In addition, an area of a component may be referred to as a size occupied by the component on a plane in parallel with a horizontal plane, and a height of the component may be referred to as a length of the component in a direction perpendicular to a direction, in which the component extends. In addition, when the components are coupled or electrically connected, the components may be simply referred to as being connected. In drawings, for convenience of illustration, only some layers may be illustrated. In addition, a pattern including a conductive material, such as a pattern of a wiring layer, may also be referred to as a conductive pattern or simply a pattern.

Each of the first through seventh blocks B1 through B7 may include a plurality of function cells. A cell may be a unit of a layout included in an integrated circuit, and may be referred to as a standard cell. A function cell may be referred to as a cell designed to perform a certain function. A block may include a plurality of various function cells, and the function cells may be aligned with a plurality of rows. For example, each of the first through seventh blocks B1 through B7 may include function cells that are placed in rows extending in the X-axis direction. A length of the function cell in the Y-axis direction may be referred to as the height of the cell, and may correspond to a width of the row. Power rails for supplying power to the function cells may extend in the X-axis direction at boundaries of the rows. For example, the power rails providing a positive supply voltage and the power rails providing a negative supply voltage may be alternately placed. In some embodiments, the widths of the rows may also be uniform or different from each other. In some embodiments, the function cells may include single height cells placed in one row and/or multiple height cells placed in two or more consecutive rows. Herein, the function cells placed in a plurality of rows in one block may be referred to as a function cell array.

The function cell may include at least one device. In some embodiments, when a fin-shaped active pattern extends in the X-axis direction and a gate electrode extends in the Y-axis direction, the active pattern and the gate electrode may form a fin field effect transistor (FET) (FinFET). In some embodiments, the active pattern may include a plurality of nanosheets apart from each other in the Z-axis direction and extending in the X-axis direction, and the function cell may include a multi-bridge channel (MBC) FET (MBCFET) formed by the gate electrode, in which the plurality of nanosheets extend in the Y-axis direction. In some embodiments, because the nanosheets for a P-type transistor and the nanosheets for an N-type transistor are separated from a dielectric wall, the function cell may also include a Forksheet FET, which includes both nFET and pFET integrated within the same structure, with a dielectric wall typically separating the nFET from the pFET.

In some embodiments, the function cell may also include a vertical FET (VFET) having a structure, in which source/drain regions are apart from each other with a channel region therebetween in the Z-axis direction, and the gate electrodes extending in the X-axis direction or Y-axis direction surround the channel region.

In some embodiments, the function cell may also include the FETs, such as a complementary FET (CFET), a negative FET (NCFET), and a carbon nanotube (CNT) FET (CNTFET), and may also include a bipolar junction transistor, and a three-dimensional transistor. It should be noted that the devices included in the function cell are not limited to the above-described examples. Hereinafter, it may be understood that the embodiments of the inventive concept are mainly described with reference to a device formed by an active pattern extending in the X-axis direction and the gate electrode extending in the Y-axis direction (for example, FinFET, MBCFET, or the like), but are also applicable to devices having other structures.

The first through seventh blocks B1 through B7 may be designed to comply with certain predetermined design rules. For example, the semiconductor process for manufacturing the integrated circuit 10 may provide multiple design rules, and block designers and/or block design programs may design blocks to comply with the design rules. In some embodiments, the design rules may define a structure required at the block boundaries. As the sizes of the devices and patterns included in the integrated circuit 10 decrease, the complexity of the semiconductor processes may increase, and the complexity of periphery structures, which are required by a semiconductor process for forming the devices and patterns having designed shapes, may increase. While the size of function cells including the devices and patterns decreases, an area occupied by the periphery structures in the layout of the integrated circuit 10 may be critical due to the above-described periphery structures.

Referring again to FIG. 1, each of the first through seventh blocks B1 through B7 may include function cells, such as the function cell array, and may include finishing cells surrounding the function cell array. The finishing cells may include periphery structures required by the semiconductor process as described above. In some embodiments, different finishing cells may be used according to placement positions. For example, as illustrated as different hatchings in FIG. 1, at the block boundary of a first block B1, finishing cells placed at first edges extending in parallel with the X-axis direction, finishing cells placed at second edges extending in parallel with the Y-axis direction, and finishing cells placed between the first edges and second edges may be different from each other. In some embodiments, the finishing cells placed at the first edges extending in parallel with the X-axis direction may have a structure terminating the gate electrodes extending in the Y-axis direction. In some embodiments, the finishing cells placed at the second edges extending in parallel with the Y-axis direction may have a structure terminating active patterns extending in the X-axis direction. Among the finishing cells, a finishing cell having a terminating structure as described above may be referred to as a termination cell.

As described above, each of the first through seventh blocks B1 through B7 may be independently designed to comply with the design rules. When the first through seventh blocks B1 through B7 are placed, a sufficient space may be inserted between the blocks (e.g., by a chip designer and/or a chip design program) to eliminate a risk that any design rules between the blocks is violated. For example, as illustrated in FIG. 1, a space H may be inserted between the first through seventh blocks B1 through B7, and the space H inserted may be referred to as a halo region. In some embodiments, the halo region may be filled with patterns to make a density of the patterns more uniform.

Thus, as illustrated in FIG. 1, the integrated circuit 10 may include areas occupied by the first through seventh blocks B1 through B7 as well as the halo region, and accordingly, there may be a limitation in reducing an overall layout area of the integrated circuit 10. As will be described below with reference to diagrams, the area of the integrated circuit 10 may be optimized according to example embodiments. In addition, a block may be designed freely from the influence caused by an adjacent block.

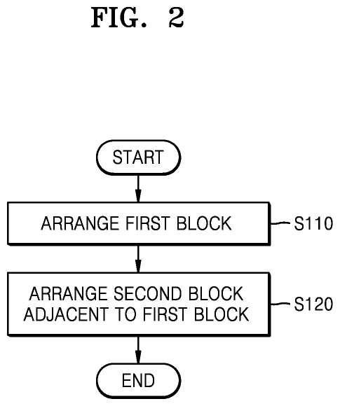

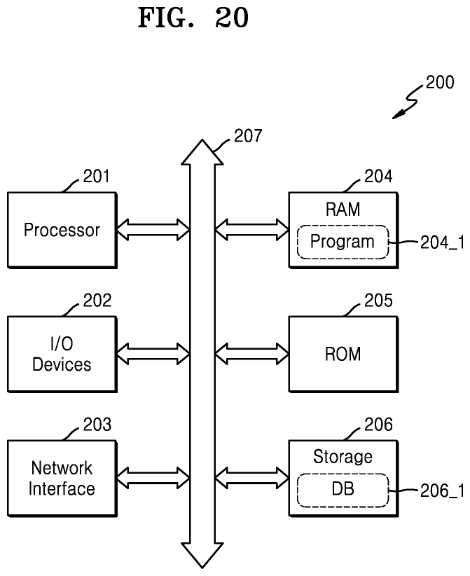

FIG. 2 is a flowchart of a method of designing an integrated circuit, according to an example embodiment. The flowchart of FIG. 2 illustrates a method of placing the first block and the second block, but without using a halo region. In some embodiments, the method of FIG. 2 may be performed by a computing system (for example, 200 in FIG. 20). Hereinafter, an example of placing the first block and the second block adjacent to each other will be mainly described. But as described above with reference to FIG. 1, it may be understood that example embodiments of the inventive concept are applicable even when three or more blocks are placed. As illustrated with reference to FIG. 2, the method of designing an integrated circuit may include operation S110 and operation S120.

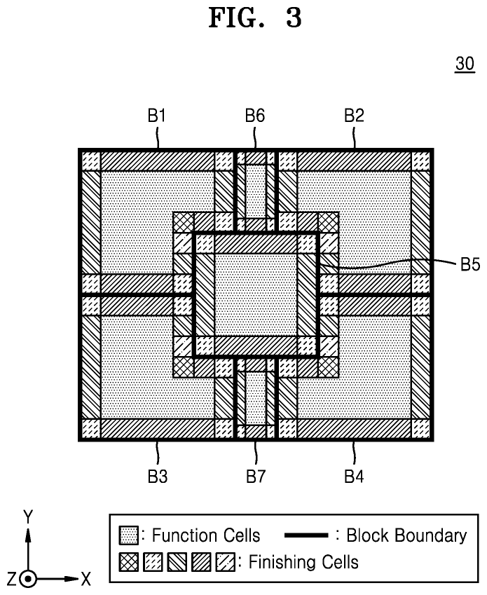

Referring to FIG. 2, the first block may be placed in operation S110. As described above with reference to FIG. 1, the first block may be designed to provide a desired function, and may include the function cell array. The second block may be placed adjacent to the first block in operation S120. As to be described below with reference to FIG. 3, the finishing cells of the first block may abut the finishing cells of the second block, so that the halo region between the first block and the second block may be removed.

In some embodiments, the first block and the second block, including the finishing cells surrounding the function cell array, may be designed. For example, in operation S110, the first block including the finishing cells may be placed, and in operation S120, the second block including the finishing cells may be placed to abut the first block. In some embodiments, the first block and the second block, which do not include the finishing cells surrounding the function cell array, may be designed. For example, in operation S110, the first block not including the finishing cells may be placed, and in operation S120, the second block not including the finishing cells may be placed adjacent to the first block, with areas for the finishing cells of the first block and the finishing cells of the second block therebetween.

FIG. 3 is a plan view of a layout of an integrated circuit 30, according to an example embodiment. As illustrated in FIG. 3, the integrated circuit 30 may include the first through seventh blocks B1 through B7. Compared to the integrated circuit 10 of FIG. 1, the halo region may be removed from the integrated circuit 30 of FIG. 3.

Referring to FIG. 3, the finishing cells may abut each other at the block boundaries between the blocks. For example, as illustrated in FIG. 3, the finishing cells of the first block B1 may abut the finishing cells of a third block B3 at the block boundary extending in parallel with the X-axis. In addition, the finishing cells of the fifth block B5 may abut the finishing cells of the remaining blocks. As illustrated in FIG. 3, in order for the blocks to abut each other without the halo region, the finishing cells placed at the block boundaries between the blocks and the finishing cells placed at an IC boundary of the integrated circuit 30 may have different structures.

For example, among the finishing cells placed at the edges of the first block B1 extending in parallel with the X-axis direction, the finishing cells placed at the block boundary between the first block B1 and the third block B3 and the finishing cells placed at the boundary of the integrated circuit 30 may have different structures. In some embodiments, the finishing cells placed at the block boundaries between the blocks may have a transitional structure, while the finishing cells placed at the boundary of an integrated circuit may have the terminating structure.

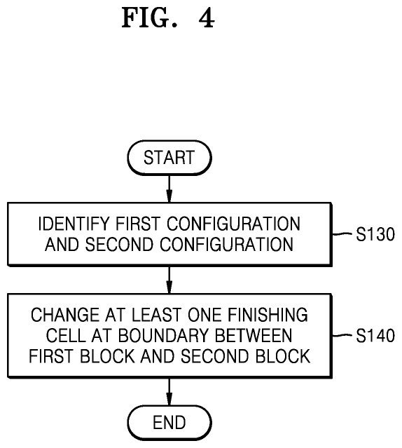

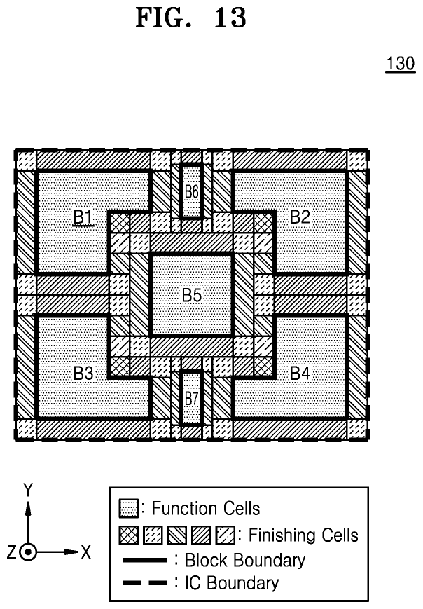

Hereinafter, examples of placing the blocks, so that the finishing cells abut each other, will be described with reference to FIGS. 4 and 13. FIG. 4 is a flowchart of a method of designing an integrated circuit, according to an example embodiment. In some embodiments, the method of FIG. 4 may be performed following operation S120 in FIG. 2. For example, the method of FIG. 4 may be performed after the first block B1 including the finishing cells and the second block B2 including the finishing cells are placed. In some embodiments, the method of FIG. 4 may be performed by a computing system (for example, 200 in FIG. 20). As illustrated in FIG. 4, the method of designing an integrated circuit may include operation S130 and operation S140.

Referring to FIG. 4, a first configuration and a second configuration may be identified in operation S130. The first configuration may correspond to a function cell array included in the first block B1, and the second configuration may correspond to a function cell array included in the second block B2. The configuration of the function cell array may include attributes related to the structure of the function cell array. For example, the configuration of the function cell array may include a gate electrode pitch, a wiring pitch, a cell height, etc. In some embodiments, the first configuration of the first block B1 may be different from the second configuration of the second block B2. For example, at least one of the gate electrode pitch, the wiring pitch, and the cell height of the first block B1 may be different from at least one of the gate electrode pitch, the wiring pitch, and the cell height of the second block B2, respectively. As to be described below, to place the appropriate finishing cells between the first block and the second block, the first configuration and the second configuration may be identified.

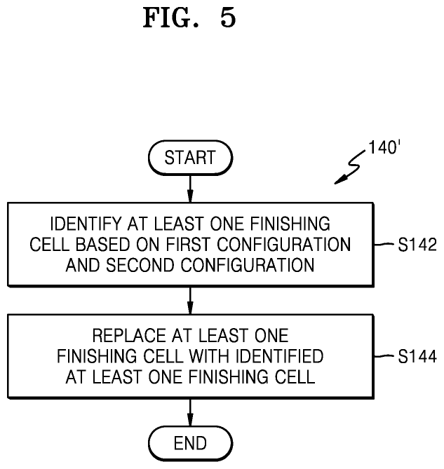

At least one finishing cell may be changed at the boundary between the first block B1 and the second block B2 in operation S140. As described above with reference to FIG. 1, the finishing cell may have the periphery structure required by the semiconductor process. For example, the finishing cells included in the first block B1 may have a structure terminating the first configuration, and the finishing cells included in the second block B2 may have a structure terminating the second configuration. The finishing cell terminating the first configuration may abut the finishing cell terminating the second configuration at the boundary between the first block B1 and the second block B2, and at least one of the abutted finishing cells may be changed to the finishing cell having a transitional structure between the first configuration and the second configuration. Accordingly, as described above with reference to FIG. 1, the halo region required for an outer periphery of the finishing cell may be removed as unnecessary. An example of operation S140 is described below with reference to FIG. 5.

FIG. 5 is a flowchart of a method of designing an integrated circuit, according to an example embodiment. The flowchart of FIG. 5 illustrates an example of operation S140 in FIG. 4. As described above with reference to FIG. 4, in operation S140′ of FIG. 5, at least one finishing cell may be changed at the boundary between the first block B1 and the second block B2. As illustrated in FIG. 5, operation S140′ may include operations S142 and S144.

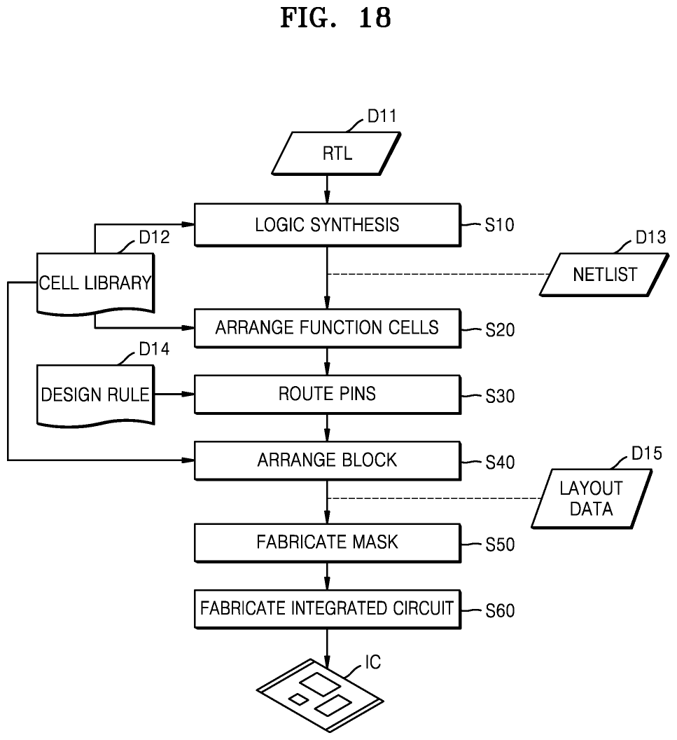

Referring to FIG. 5, at least one finishing cell may be identified based on the first configuration and the second configuration in operation S142. For example, at least one finishing cell having a transient structure between the first configuration and the second configuration may be identified. The semiconductor process may provide available configurations to the block designer, and the block may be designed according to one of the available configurations. Transition cells respectively corresponding to combinations of two configurations among the available configurations may be defined, and the transition cell may have a transient structure between the two configurations. For example, the transition cell may include at least one of a structure separating the power rails, a structure separating the active patterns, a structure separating the gate electrodes, a structure separating wirings, a structure separating device regions (or other active regions), and a structure separating wells. The first configuration (or the second configuration) may be appropriately transitioned to the second configuration (or the first configuration) by the transition cell. In some embodiments, the transition cells may be defined by a cell library (for example, D12 in FIG. 18), and the transition cells corresponding to the first and second configurations may be identified in the cell library.

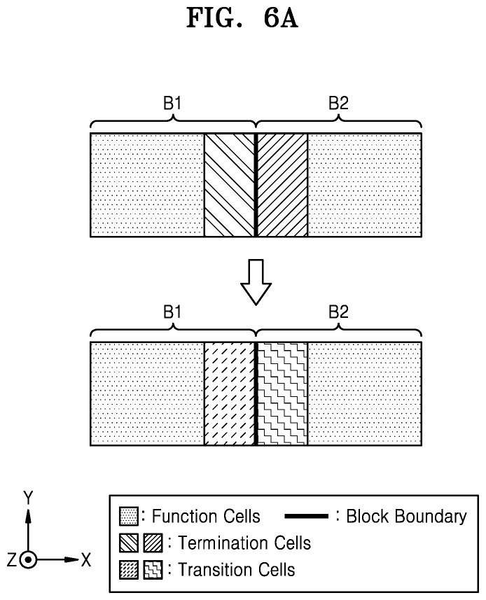

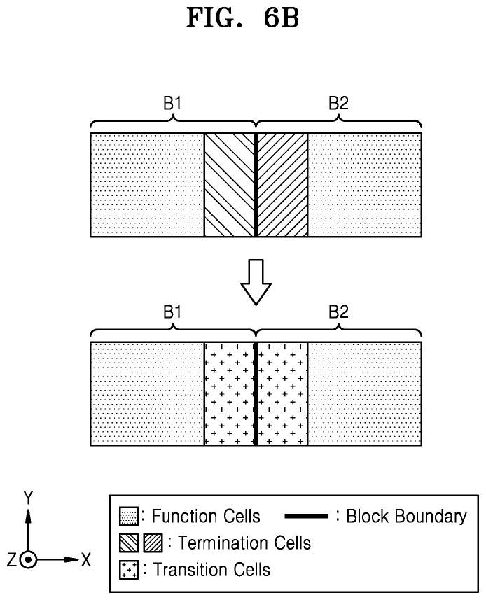

At least one finishing cell may be replaced with an “identified” at least one finishing cell in operation S144. For example, at least one finishing cell placed at the boundary between the first block B1 and the second block B2 may be replaced with the at least one finishing cell identified in operation S142, that is, at least one transition cell. Examples, in which the at least one finishing cell is replaced, are described below with reference to FIGS. 6A and 6B.

FIGS. 6A and 6B are diagrams illustrating the block boundaries between the blocks, according to example embodiments. FIGS. 6A and 6B illustrate examples, in which at least one finishing cell is changed at the block boundary between the first block B1 and the second block B2. Referring to FIG. 6A, in some embodiments, both the finishing cell of the first block B1 and the finishing cell of the second block B2 may be replaced. As illustrated in an upper portion of FIG. 6A, the second block B2 may be placed to abut the first block B1, which means the finishing cell of the first block B1 may abut the finishing cell of the second block B2 at the block boundary between the first block B1 and the second block B2. As illustrated in a lower portion of FIG. 6A, the finishing cell of the first block B1 may be replaced with a transition cell, which has been identified based on: (i) the first configuration of the first block B1, and (ii) the second configuration of the second block B2. In addition, the finishing cell of the second block B2 may be replaced with a transition cell, which has been identified based on: (i) the first configuration of the first block B1, and (ii) the second configuration of the second block B2. Due to the transition cells abutting the block boundary between the first block B1 and the second block B2, the first configuration (or the second configuration) may be appropriately transitioned to the second configuration (or the first configuration).

Referring to FIG. 6B, in some embodiments, the finishing cell of the first block B1 and the finishing cell of the second block B2 may be replaced with one cell. As illustrated in an upper portion of FIG. 6B, the second block B2 may be placed to abut the first block B1, such that the finishing cell of the first block B1 may abut the finishing cell of the second block B2 at the block boundary between the first block B1 and the second block B2. As illustrated in a lower portion of FIG. 6B, the finishing cell of the first block B1 and the finishing cell of the second block B2 may be replaced with one transition cell, which has been identified based on the first configuration of the first block B1 and the second configuration of the second block B2. In other words, the transition cell of FIG. 6B may cross the block boundary between the first block B1 and the second block B2.

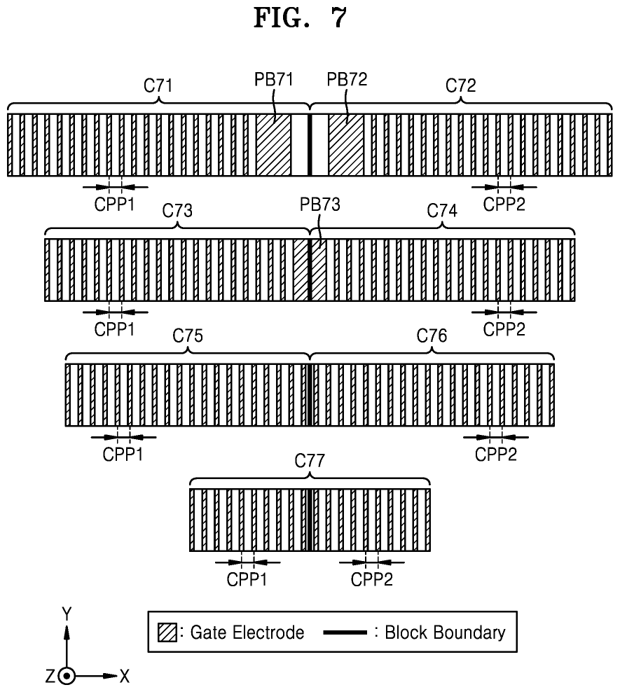

FIG. 7 illustrates examples of a transition cell according to an example embodiment. FIG. 7 illustrates examples of transition cells placed at the block boundaries extending in parallel with the Y-axis. In FIG. 7, a first gate electrode pitch CPP1 may be the same as or different from a second gate electrode pitch CPP2.

Referring to FIG. 7, in some embodiments, the transition cell may include a gate electrode having a greater width than the gate electrode included in the function cells. For example, as illustrated in FIG. 7, a first transition cell C71 may include a first gate electrode PB71 having a greater width than a width of each of the gate electrodes extending with the first gate electrode pitch CPP1 in the Y-axis direction. In addition, the second transition cell C72 may include a second gate electrode PB72 having a greater width than a width of each of the gate electrodes extending with the second gate electrode pitch CPP2 in the Y-axis direction. In some embodiments, wide gate electrodes may support the active patterns extending in parallel with each other in the X-axis direction. As illustrated in FIG. 7, the first gate electrode PB71 and the second gate electrode PB72 may be apart from each other with the block boundary extending therebetween in the X-axis direction.

In some embodiments, the transition cells abutting at the block boundary may share gate electrodes having a relatively large width. For example, as illustrated in FIG. 7, a third transition cell C73 and a fourth transition cell C74 may abut each other at the block boundary, and may share a third gate electrode PB73 having a large width. Accordingly, a length in the X-axis direction occupied by the third transition cell C73 and the fourth transition cell C74 may be less than a length in the X-axis direction occupied by the first transition cell C71 and the second transition cell C72.

In some embodiments, the gate electrodes having a large width at the block boundaries may be omitted. For example, as illustrated in FIG. 7, a fifth transition cell C75 and a sixth transition cell C76 may abut each other at the block boundary, and a gate electrode having the large width may be omitted. Accordingly, a length in the X-axis direction occupied by the fifth transition cell C75 and the sixth transition cell C76 may be less than a length in the X-axis direction occupied by the third transition cell C73 and the fourth transition cell C74 described above. In some embodiments, an active pattern pitch of the block (for example, the first block B1) including the fifth transition cell C75 may be the same as the active pattern pitch of the block (for example, the second block B2) including the sixth transition cell C76.

In some embodiments, one transition cell crossing the block boundary may be placed between the blocks. For example, as illustrated in FIG. 7, a seventh transition cell C77 crossing the block boundary may be placed, and a gate electrode having a relatively large width in the seventh transition cell C77 may be omitted. In some embodiments, the transition cell may include a well tap for biasing the well, and the blocks (that is, the first block B1 and the second block B2) may share the well tap by the seventh transition cell C77.

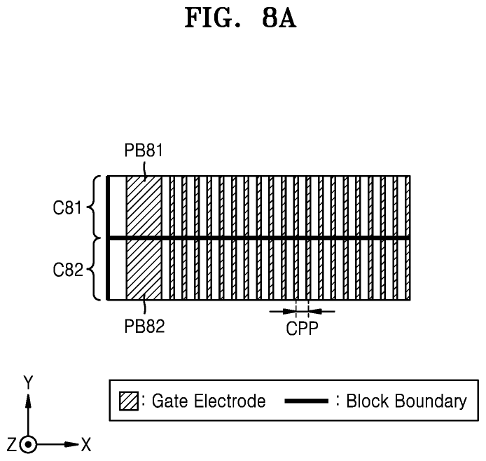

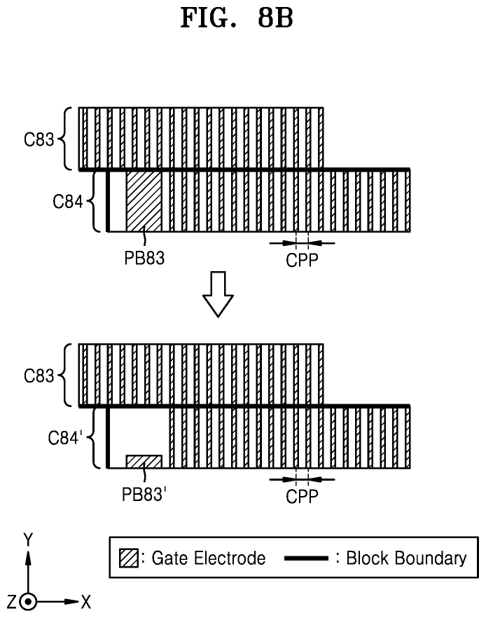

FIGS. 8A and 8B illustrate examples of a transition cell, according to example embodiments. FIGS. 8A and 8B illustrate examples of transition cells placed at the block boundaries extending in parallel with the X-axis. In FIGS. 8A and 8B, it may be assumed that the blocks have the same gate electrode pitch CPP.

Referring to FIG. 8A, the first transition cell C81 may abut the second transition cell C82 at the block boundary extending in parallel with the X-axis. The first transition cell C81 may include a first gate electrode PB81 having a large width, and the second transition cell C82 may include a second gate electrode PB82 having a large width. As illustrated in FIG. 8A, the first gate electrode PB81 may be connected to the second gate electrode PB82 at the block boundary.

Referring to an upper portion of FIG. 8B, a third transition cell C83 may abut a fourth transition cell C84 at the block boundary extending in parallel with the X-axis. The third transition cell C83 may not include a gate electrode having a large width, while the fourth transition cell C84 may include a third gate electrode PB83 having a large width due to the block boundary extending in parallel with the Y-axis. Accordingly, in the third transition cell C83, the gate electrodes extending while being apart by the gate electrode pitch CPP, may be affected by the third gate electrode PB83. Accordingly, as illustrated in a lower portion of FIG. 8B, a portion of the third gate electrode PB83 may be removed from the block boundary, and instead of the fourth transition cell C84, a fourth transition cell C84′ including a shortened third gate electrode PB83′ may be used. In some embodiments, the fourth transition cell C84 illustrated in the upper portion of FIG. 8B may be changed to the fourth transition cell C84′ illustrated in the lower portion of FIG. 8B. In some embodiments, the fourth transition cell C84 illustrated in the upper portion of FIG. 8B may be replaced with the fourth transition cell C84′ illustrated in the lower portion of FIG. 8B.

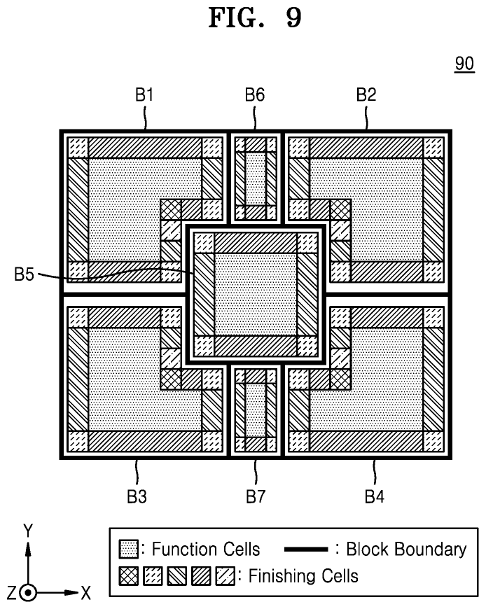

FIG. 9 is a plan view illustrating a layout of an integrated circuit 90, according to an example embodiment. As illustrated in FIG. 9, the integrated circuit 90 may include the first through seventh blocks B1 through B7. Compared to the integrated circuit 10 of FIG. 1, the integrated circuit 90 of FIG. 9 may include the halo region having a reduced area. Hereinafter, FIG. 9 is described with reference to FIG. 1.

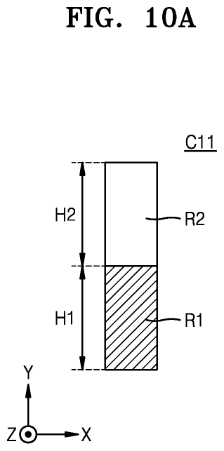

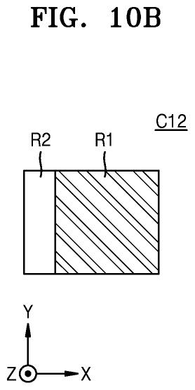

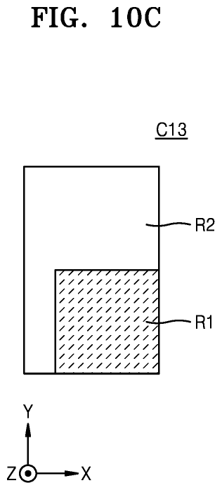

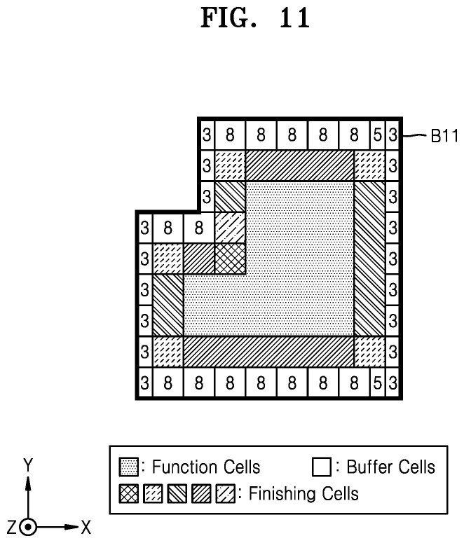

In some embodiments, the blocks may include the halo regions. For example, the first block B1 in FIG. 1 may have the block boundary formed by the finishing cells, whereas the first block B1 in FIG. 9 may have the block boundary formed by the halo region at an outer edge of the finishing cells. Accordingly, in the layout of the integrated circuit 90, the first through seventh blocks B1 through B7 may be placed to abut each other, and additional halo regions may be omitted. The integrated circuit 90 of FIG. 9 may include a halo region, which is reduced from the halo region of the integrated circuit 10 of FIG. 1, and may have a smaller area than the integrated circuit 10 of FIG. 1. Examples of the blocks including the halo region will be described with reference to FIGS. 10A through 10C and 11.

FIGS. 10A through 10C are diagrams illustrating examples of the finishing cells, according to example embodiments. FIGS. 10A through 10C illustrate examples of the finishing cell including the halo region. As described above with reference to FIG. 9, a block may include a halo region, and the halo region included in the block may be provided by a finishing cell including the halo region. Hereinafter, it may be assumed that the finishing cells in FIGS. 10A through 10C are included in the first block.

Referring to FIG. 10A, a first finishing cell C11 may be placed at the block boundary extending in parallel with the X-axis direction. The first finishing cell C11 may include a first region R1 having a structure terminating the first configuration of the first block B1 and a second region R2 corresponding to the halo region. In addition, the first block B1 may include the finishing cell symmetrical to the first finishing cell C11 with respect to the X-axis. In some embodiments, the first finishing cell C11 may correspond to a double height cell. For example, as illustrated in FIG. 10A, the first region R1 and the second region R2 may have a first height H1 and a second height H2, respectively, which correspond to widths of rows, in which the function cells of the first block B1 are placed. The first height H1 may be the same as or different from the second height H2.

Referring to FIG. 10B, a second finishing cell C12 may be placed at the block boundary extending in parallel with the Y-axis direction. The second finishing cell C12 may include the first region R1 having a structure terminating the first configuration of the first block B1 and the second region R2 corresponding to the halo region. In addition, the first block B1 may include the finishing cell symmetrical to the second finishing cell C12 with respect to the Y-axis.

Referring to FIG. 10C, a third finishing cell C13 may be placed, at the block boundary, at a corner between an edge extending in parallel with the X-axis and an edge extending in parallel with the Y-axis. The third finishing cell C13 may include the first region R1 having a structure terminating the configuration of the first block B1 and the second region R2 corresponding to the halo region. In addition, the first block B1 may include the finishing cells, obtained by respectively rotating the third finishing cell C13 by 90°, 180°, and 270°, at the corners.

FIG. 11 is a plan view illustrating a block B11 according to an example embodiment. The plan view of FIG. 11 illustrates the block B11 including buffer cells. The buffer cell may provide the halo region described above with reference to FIG. 9. In some embodiments, the buffer cell may be defined in the cell library (for example, D12 in FIG. 18).

In some embodiments, the block B11 may include a plurality of buffer cells surrounding the finishing cells. For example, as illustrated in FIG. 11, the block B11 may include the finishing cells surrounding the function cell array, and may include the buffer cells surrounding the finishing cells. Unlike the finishing cells described above with reference to FIGS. 10A through 10C, the finishing cells included in the block B11 of FIG. 11 may have a structure terminating the configuration of the block B11, and may not include a region corresponding to the halo region. The buffer cells may be placed independently of the finishing cells. For example, the number shown in the buffer cell in FIG. 11 may indicate a size (for example, a width) of the buffer cell, and appropriate buffer cells may be placed according to the total length of the finishing cells placed.

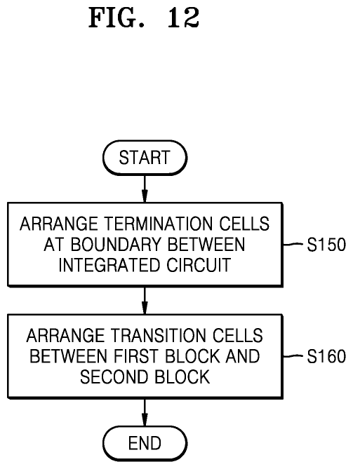

FIG. 12 is a flowchart of a method of designing an integrated circuit, according to an example embodiment, and FIG. 13 is a plan view of a layout of an integrated circuit 130, according to an example embodiment. The plan view of FIG. 13 illustrates an example of an integrated circuit designed by the method of FIG. 12. In some embodiments, the method of FIG. 12 may be performed by a computing system (for example, 200 in FIG. 20).

In some embodiments, the method of FIG. 12 may be performed following operation S120 in FIG. 2. For example, the method of FIG. 12 may be performed after the first block B1 and the second block B2, which do not include the finishing cells, are placed. In some embodiments, after the blocks including the finishing cells are placed, the method of FIG. 12 may be performed in a state where the finishing cells have been removed. For example, as illustrated in FIG. 13, the integrated circuit 130 may include the first through seventh blocks B1 through B7. Each of the first through seventh blocks B1 through B7 may have the boundary defined by the function cell array.

Referring to FIG. 12, the method of designing an integrated circuit may include operation S150 and operation S160. The termination cells may be placed at the boundaries of an integrated circuit in operation S150. As described above, the termination cells may have a structure terminating the configurations of the blocks. For example, in FIG. 13, the finishing cells placed at the integrated circuit (IC) boundary of the integrated circuit 130 may include the termination cells.

The transition cells may be placed between the first block B1 and the second block B2 in operation S160. As described above, the transition cells may have a transition structure between configurations of adjacent blocks. For example, in FIG. 13, the finishing cells placed between the first through seventh blocks B1 through B7 may include the transition cells.

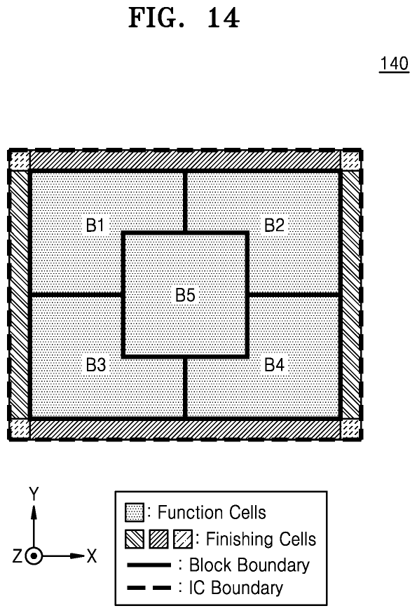

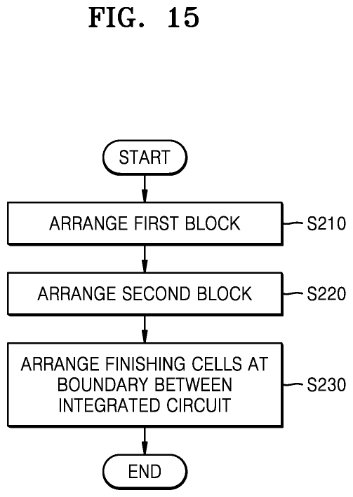

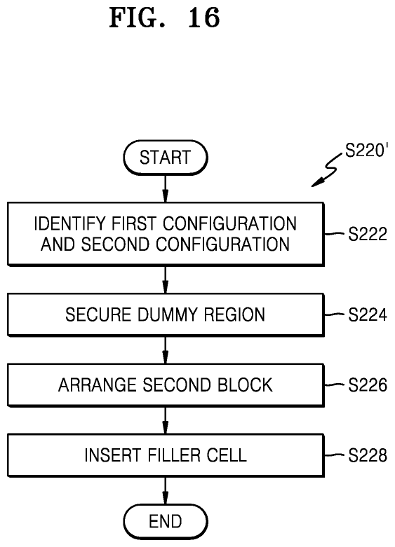

FIG. 14 is a plan view illustrating a layout of an integrated circuit 140, according to an example embodiment. As illustrated in FIG. 14, the integrated circuit 140 may include the first through fifth blocks B1 through B5. Unlike the integrated circuits described above with reference to the drawings, the finishing cells may be omitted between the first through fifth blocks B1 through B5 in the integrated circuit 140 of FIG. 14. Accordingly, the finishing cells, that is, the termination cells, may be placed at the IC boundary of the integrated circuit 140, whereas the first through fifth blocks B1 through B5 may abut each other, and the finishing cells may be omitted at the block boundaries between the blocks. As to be described with reference to FIG. 16, a dummy region having a width corresponding to several gate electrode pitches may be provided between the blocks, and the width of the dummy region may be significantly less than the width of the termination cell. Accordingly, in the inventive concept, the blocks placed with the dummy region therebetween may be referred to as blocks abutting each other. Hereinafter, examples of method of designing abutted blocks will be described with reference to FIGS. 15 and 16.

FIG. 15 is a flowchart illustrating a method of designing an integrated circuit, according to an example embodiment. The flowchart of FIG. 15, as described above with reference to FIG. 14, illustrates a method of designing an integrated circuit such that the blocks abut each other without the finishing cell. As illustrated with reference to FIG. 15, the method of designing an integrated circuit may include a plurality of operations S210, S220, and S230.

Referring to FIG. 15, the first block B1 may be placed in operation S210. In some embodiments, when the first block B1 includes the finishing cells, the finishing cells may be removed from the first block B1, and the first block B1, from which the finishing cells are removed, may be placed. The second block B2 may be placed in operation S220. In some embodiments, when the second block B2 includes the finishing cells, the finishing cells may be removed from the second block B2, and the second block B2, from which the finishing cells are removed, may be placed. As to be described below with reference to FIG. 16, the second block B2 may be placed adjacent to the first block with the dummy region between the first block B1 and the second block B2. An example of the operation S220 is described below with reference to FIG. 16. The finishing cells may be placed at the IC boundary of an integrated circuit in operation S230. For example, the termination cells may be placed at the IC boundary of an integrated circuit.

FIG. 16 is a flowchart of a method of designing an integrated circuit, according to an embodiment. The flowchart of FIG. 16 may illustrate an example of operation S220 in FIG. 15. As described above with reference to FIG. 15, in operation S220′ of FIG. 16, the second block B2 may be placed. As illustrated in FIG. 16, operation S220′ may include a plurality of operations S222, S224, S226, and S228.

Referring to FIG. 16, the first configuration and the second configuration may be identified in operation S222. Similar to operation S130 in FIG. 4, the first configuration of the first block B1 and the second configuration of the second block B2 may be identified.

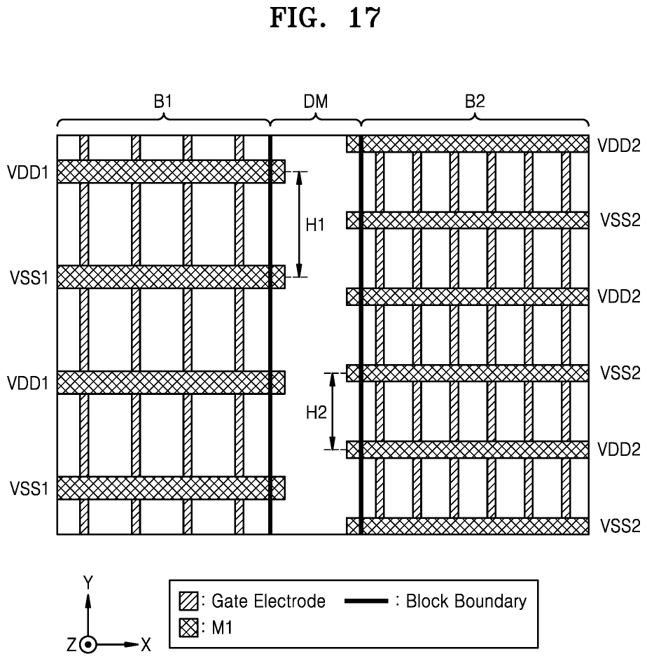

The dummy region may be reserved in operation S224. For example, the first configuration of the first block B1 may be different from the second configuration of the second block B2, and accordingly, when the function cell array of the first block B1 abuts the function cell array of the second block B2, the design rules may be violated. Accordingly, instead of placing the termination cell or the transition cell between the first block B1 and the second block B2, the dummy region may be inserted between the first block B1 and the second block B2 such that the first configuration is separated from the second configuration. In some embodiments, the dummy region may have a width of the several gate electrode pitches of the first block B1 or the second block B2. The width of the dummy region, that is, a space between the first block B1 and the second block B2, may be determined based on the first configuration and the second configuration. For example, when the difference between the first configuration and the second configuration is large, the dummy region may have a large width, whereas when the difference between the first configuration and the second configuration is small, the dummy region may have a small width. An example of the dummy region is described below with reference to FIG. 17.

The second block B2 may be placed in operation S226. For example, the second block B2 may be placed to abut the dummy region reserved in operation S224. A filler cell may be inserted in operation S228. For example, the filler cell may be inserted into the dummy region reserved in operation S224. The filler cell may be referred to a cell to be inserted between the function cells in the function cell array, and may be different from the finishing cell. As to be described below with reference to FIG. 17, the power rails or the like may be isolated from each other in the filler cell placed in the dummy region.

FIG. 17 is a diagram illustrating block boundaries, according to an example embodiment. FIG. 17 illustrates an example, in which a dummy region DM operates as a spacer region between the first block B1 and the second block B2. As described above with reference to FIG. 16, the dummy region DM may be reserved between the first block B1 and the second block B2, and the filler cells may be placed in the dummy region.

Referring to FIG. 17, the first block B1 may include the function cells placed in rows each having a width corresponding to the first height H1. Accordingly, the patterns (that is, the power rails), to which a positive supply voltage VDD1 or a negative supply voltage VSS1 is applied on a first wiring layer M1, may extend in parallel with the X-axis. Similarly, the second block B2 may include the function cells placed in rows each having a width corresponding to the second height H2 different from the first height H1. Accordingly, the patterns (that is, the power rails), to which a positive supply voltage VDD2 or a negative supply voltage VSS2 is applied on a first wiring layer M1, may extend in parallel with the X-axis.

As illustrated in FIG. 17, the first block B1 and the second block B2 may have different configurations (that is, different power rail pitches), and accordingly, the power rails may be isolated from each other in the dummy region DM. For example, as illustrated in FIG. 17, the power rails may extend into the dummy region DM, and may be terminated inside the dummy region DM. In addition, the power rails of the first block B1 may be disconnected from the power rails of the second block B2 in the dummy region DM. Although FIG. 17 illustrates an example, in which the power rails are isolated from each other in the dummy region DM, other structures for example, wiring patterns, device regions, wells, and active patterns, or the like may be isolated from each other in the dummy region DM.

FIG. 18 is a flowchart of a method of manufacturing an integrated circuit IC, according to an example embodiment. The flowchart of FIG. 18 illustrates an example of a method of manufacturing the integrated circuit IC including abutting blocks. As illustrated in FIG. 18, a method for manufacturing the integrated circuit IC may include a plurality of operations S10 through S60.

A cell library (or standard cell library) D12 may include information about cells, such as function information, characteristic information, and layout information. In some embodiments, the cell library D12 may define the finishing cells as well as the function cells as described above with reference to the drawings. For example, the cell library D12 may define the termination cells corresponding to the block configuration and the transition cells respectively corresponding to combinations of two blocks. Design rule D14 may include requirements to be complied with by a layout of the integrated circuit IC. For example, the design rule D14 may include requirements for a space between the patterns, a minimum width of the pattern, a routing direction of the wiring layer, etc. In some configurations, the design rule D14 may define a periphery structure of the blocks.

A logic synthesis operation for generating a netlist D13 from an RTL data D11 may be performed in operation S10. For example, a semiconductor design tool (for example, a logic synthesis tool) may generate the netlist D13 including a bitstream or a netlist, by performing a logical synthesis by referring to the cell library D12 from the RTL data D11 prepared in a hardware description language (HDL), such as very high speed integrated circuit (VHSIC) hardware description language (VHDL), and Verilog. The netlist D13 may correspond to an input of placement and routing to be described below.

The function cells may be placed in operation S20. For example, the semiconductor design tool (for example, a placement and routing (P&R) tool) may place the function cells used in the netlist D13 with reference to the cell library D12. In some embodiments, the semiconductor design tool may place the function cells used in the netlist D13 as well as additional cells (for example, filler cells).

Pins may be routed in operation S30. For example, the semiconductor design tool may generate interconnections electrically connecting output pins of the placed functional cells to input pins of the placed functional cells, and may generate data defining placed function cells and generated interconnections. The interconnection may include a via of a via layer and/or a pattern of the wiring layer. Accordingly, data defining a block may be generated, and the data may include geometric information about the function cells and the interconnections.

The blocks may be placed in operation S40. For example, the blocks generated in operation S30 may be placed, and layout data D15 may be generated. The layout data D15 may have a format, such as graphic design system information interchange (GDSII), and may include geometric information about the layout of the integrated circuit IC. As illustrated in FIG. 18, the cell library D12 and the design rule D14 may be referenced to, when the block is placed. Herein, operation S40 alone or operations S20 through S40 may be referred to as a method of collectively designing the integrated circuit IC.

An operation of fabricating a mask may be performed in operation S50. For example, in photolithography, an optical proximity correction (OPC) for correcting a distortion phenomenon, such as refraction due to characteristics of light, may be applied to the layout data D15. Patterns on the mask may be defined to form the patterns placed on a plurality of layers based on the data, to which the OPC has been applied, and at least one mask (or a photomask) for forming respective patterns of the plurality of layers may be fabricated. In some embodiments, the layout of the integrated circuit IC may be limitedly modified in operation S50, and the limited modification on the integrated circuit IC in operation S50 may be a post process for optimizing a structure of the integrated circuit IC, and may be referred to as a design polishing process.

An operation of manufacturing the integrated circuit IC may be performed in operation S60. For example, the integrated circuit IC may be manufactured by patterning the plurality of layers by using at least one mask fabricated in operation S50. A front-end-of-line (FEOL) process may include, for example, planarizing and cleaning a wafer, forming a trench, forming a well, forming a gate electrode, and forming a source and a drain, and individual devices, for example, a transistor, a capacitor, a resistor, or the like may be formed on a substrate by using the FEOL process. In addition, a back-end-of-line (BEOL) process may include, for example, silicidation of a gate region, a source region, and a drain region, adding a dielectric material, planarization, forming of a hole, adding a metal layer, forming of a via, forming a passivation layer, or the like, and individual devices, for example, a transistor, a capacitor, a resistor, or the like may be interconnected to each other by using the BEOL process. In some embodiments, a middle-end-of-line (MEOL) process may be performed between the FEOL and BEOL processes, and contacts may be formed on individual devices. Next, the integrated circuit IC may be packaged in a semiconductor package, and used as a component of various applications.

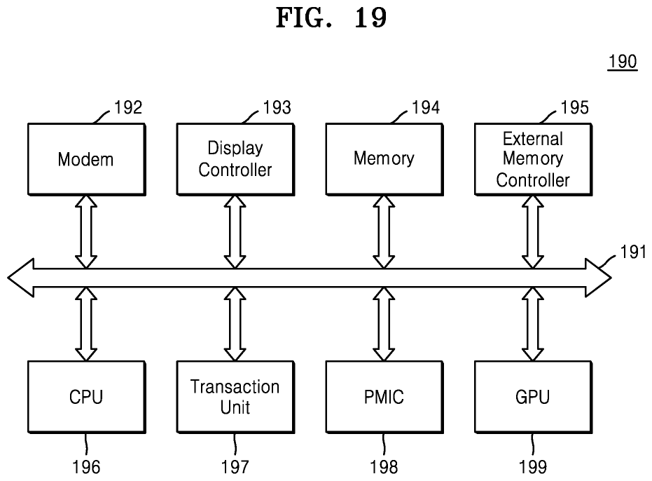

FIG. 19 is a block diagram of a system on chip (SoC) 190, according to an example embodiment. The SoC 190 may include a semiconductor device, and may include an integrated circuit (IC) according to an example embodiment. The SoC 190 may include one chip, in which complex blocks such as intellectual property (IP) are implemented, may be designed by a method of designing the integrated circuit (IC) according to example embodiments, and thus, may have a reduced area. Referring to FIG. 19, the SoC 190 may include a modem 192, a display controller 193, a memory 194, an external memory controller 195, a central processing unit (CPU) 196, a transaction unit 197, a power management integrated circuit (PMIC) 198, and a graphics processing unit (GPU) 199, and functional blocks of the SoC 190 may communicate with each other via a system bus 191.

The CPU 196 capable of controlling operations of the SoC 190 on the uppermost layer may control operations of the other functional blocks, such as 192 through 199. The modem 192 may demodulate a signal received from the outside of the SoC 190, or modulate a signal generated inside the SoC 190 and transmit the signal to the outside. The external memory controller 195 may control an operation of transceiving data to and from an external memory device connected to the SoC 190. For example, programs and/or data stored in the external memory device may be provided to the CPU 196 or the GPU 199 under the control of the external memory controller 195. The GPU 199 may execute program instructions related to graphics processing. The GPU 199 may receive graphics data via the external memory controller 195, or transmit the graphics data processed by the GPU 199 to the outside of the SoC 190 via the external memory controller 195. The transaction unit 197 may monitor data transactions of each of the functional blocks, and the PMIC 198 may control power supplied to each functional block according to the control of the transaction unit 197. The display controller 193 may transmit data generated inside the SoC 190 to a display, by controlling the display (or a display device) outside the SoC 190. The memory 194 may include a non-volatile memory, such as an electrically erasable programmable read-only memory (ROM) (EEPROM), and a flash memory, and may include a volatile memory, such as dynamic random access memory (RAM) DRAM and static RAM (SRAM).

FIG. 20 is a block diagram illustrating a computing system 200 including a memory for storing a program, according to an example embodiment. At least a portion of a method of designing an integrated circuit, for example, a portion of operations of the described above flowcharts, according to example embodiments may be performed by the computing system (or a computer) 200.

The computing system 200 may include a stationary computing system, such as a desktop computer, a workstation, and a server, or may also include a portable computing system, such as a laptop computer. As illustrated in FIG. 20, the computing system 200 may include a processor 201, an input/output (I/O) devices 202, a network interface 203, an RAM 204, an ROM 205, and a storage device 206. The processor 201, the I/O devices 202, the network interface 203, the RAM 204, the ROM 205, and the storage device 206 may be connected to the bus 207, and may communicate with each other via the bus 207.

The processor 201 may be referred to as a processing unit, and may include at least one core capable of executing an arbitrary instruction set (for example, Intel Architecture-32 (IA-32), 64-bit extensions to IA-32, x86-64, PowerPC, scalable processor architecture (SPARC), a microprocessor without interlocked pipeline stages (MIPS), an Advanced reduced instruction set computer (RISC) machine (ARM), Intel Architecture-62 (IA-64), etc.), such as a micro-processor, an application processor (AP), a digital signal processor (DSP), and a GPU. For example, the processor 201 may access a memory, that is, the RAM 204 or the ROM 205 via the bus 207, and may execute instructions stored in the RAM 204 or the ROM 205.

The RAM 204 may store a program 204_1 for a method of designing an integrated circuit according to an example embodiment, or may store at least a portion thereof, and the program 204_1 may cause the processor 201 to perform at least a portion of operations included in a method of designing an integrated circuit, for example, the method of FIG. 9. In other words, the program 204_1 may include a plurality of instructions executable by the processor 201, and the plurality of instructions included in the program 204_1 may cause the processor 201 to perform at least a portion of operations included in the described above flowcharts.

The storage device 206 may not lose stored data even when the power supplied to the computing system 200 is cut off. For example, the storage device 206 may also include a non-volatile memory device, or a storage medium, such as a magnetic tape, an optical disk, and a magnetic disk. In addition, the storage device 206 may also be detachable from the computing system 200. The storage device 206 may also store the program 204_1 according to an example embodiment, and before the program 204_1 is executed by the processor 201, the program 204_1 or at least a portion thereof may be loaded into the RAM 204 from the storage device 206. Alternatively, the storage device 206 may store a file written in a program language, and the program 204_1 generated from the file by a compiler or the like or at least a portion thereof may be loaded into the RAM 204. In addition, as illustrated in FIG. 20, the storage device 206 may store a database (DB) 206_1, and the database 206_1 may include information necessary for designing an integrated circuit, for example, information about designed blocks, the cell library D12, and/or the design rule D14 in FIG. 18.

The storage device 206 may also store data to be processed by the processor 201 or data processed by the processor 201. In other words, the processor 201 may, according to the program 204_1, generate data by processing the data stored in the storage device 206, and may store the generated data in the storage device 206. For example, the storage device 206 may store the RTL data D11, the netlist D13, and/or the layout data D15 in FIG. 18.

The I/O devices 202 may include an input device, such as a keyboard and a pointing device, and may include an output device, such as a display device and a printer. For example, a user may also, via the I/O devices 202, trigger execution of the program 204_1 by using the processor 201, may also input the RTL data D11 and/or the netlist D13 in FIG. 18, and may also identify the layout data D15 in FIG. 18.

The network interface 203 may provide an access to a network outside the computing system 200. For example, the network may include a plurality of computing systems and communication links, and the communication links may include wired links, optical links, wireless links, or any other types of links.

While the inventive concept has been particularly shown and described with reference to embodiments thereof, it will be understood that various changes in form and details may be made therein without departing from the spirit and scope of the following claims.

1. A method of designing an integrated circuit, comprising:
placing a first block including a first function cell array into a layout of the integrated circuit; and
placing a second block including a second function cell array into the layout of the integrated circuit, such that the second block extends adjacent the first block within the layout;
wherein the first block includes first finishing cells that extend along a boundary of the first block, and the second block includes second finishing cells that extend along a boundary of the second block; and
wherein at least some of the first finishing cells abut at least some of the second finishing cells within the layout, at a boundary between the first and second blocks.

2. The method of claim 1, wherein at least one of the first finishing cells comprises a structure terminating a first configuration of the first function cell array; and wherein at least one of the second finishing cells comprises a structure terminating a second configuration of the second function cell array.

3. The method of claim 2, further comprising changing at least one finishing cell among the first finishing cells and the second finishing cells, at the respective boundary of the first block and the second block.

4. The method of claim 3, wherein said changing at least one finishing cell comprises identifying a finishing cell having a transitional structure, and replacing a finishing cell at a respective boundary with the identified finishing cell.

5. The method of claim 3, wherein said changing at least one finishing cell comprises replacing one of the first finishing cells and one of the second finishing cells, which abut each other at a boundary, with one finishing cell.

6. The method of claim 2,
wherein each of the first finishing cells comprises a first region that abuts the first function cell array and has a structure terminating the first configuration, and a second region that abuts the first region and includes a halo region;
wherein each of the second finishing cells comprises a third region that abuts the second functional cell array and has a structure terminating the second configuration, and a fourth region that abuts the third region and includes a halo region.

7. The method of claim 6, wherein the first function cell array comprises function cells aligned to a plurality of rows extending in a first direction; and wherein the first finishing cells include a finishing cell having a height corresponding to two or more of the plurality of rows.

8. The method of claim 2, wherein the first block comprises a plurality of first buffer cells surrounding the first finishing cells; and wherein the second block comprises a plurality of second buffer cells surrounding the second finishing cells.

9. The method of claim 2, wherein the first configuration comprises a gate electrode pitch, a wiring pitch, and a cell height in the first function cell array; and wherein the second configuration comprises a gate electrode pitch, a wiring pitch, and a cell height in the second function cell array.

10. The method of claim 1, further comprising:
placing third finishing cells at a boundary of the integrated circuit; and
placing fourth finishing cells between the first block and the second block,
wherein the third finishing cells have a structure terminating a first configuration of the first function cell array or a second configuration of the second function cell array; and
wherein the fourth finishing cells have a transitional structure between the first configuration and the second configuration.

11. The method of claim 10,
wherein said placing the first block comprises removing a plurality of first finishing cells surrounding the first function cell array; and
wherein said placing the second block comprises removing a plurality of second finishing cells surrounding the second function cell array.

12. The method of claim 1, further comprising:
generating data defining the first block and the second block, which have been placed;
fabricating at least one mask based on the data; and
manufacturing the integrated circuit using the at least one mask.

13. A method of designing an integrated circuit, comprising:
placing a first block including a first function cell array into a layout of the integrated circuit; and
placing a second block including a second function cell array into the layout of the integrated circuit, such that the second block extends adjacent the first block within the layout, said placing a second block comprising securing a dummy region between the first block and the second block, such that the second block abuts the dummy region.

14. The method of claim 13, wherein said placing the second block comprises:
identifying a first configuration of the first function cell array and a second configuration of the second function cell array; and
based on the first configuration and the second configuration, inserting at least one filler cell into the dummy region.

15. The method of claim 14,
wherein the first configuration comprises a gate electrode pitch, a wiring pitch, and a cell height in the first function cell array; and
wherein the second configuration comprises a gate electrode pitch, a wiring pitch, and a cell height in the second function cell array.

16. The method of claim 13, further comprising:
placing at least one finishing cell at a boundary of the integrated circuit,
wherein the placing the at least one finishing cell comprises:
placing a first finishing cell at a first edge extending in parallel with a first direction;
placing a second finishing cell at a second edge extending in parallel with a second direction crossing the first direction; and
placing a third finishing cell at a corner between the first edge and the second edge.

17. The method of claim 16, further comprising:
generating data defining the first block, the second block, and the at least one finishing cell that have been placed;
fabricating at least one mask based on the data; and
manufacturing the integrated circuit by using the at least one mask.

18. An integrated circuit comprising:
a first block including a first function cell array therein, which is at least partially surrounded by a first plurality of finishing cells; and
a second block extending adjacent the first block, said second block including a second function cell array therein, which is at least partially surrounded by a second plurality of finishing cells;
wherein the first plurality of finishing cells include: (i) a first finishing cell placed at a boundary of the integrated circuit, and (ii) a second finishing cell different from the first finishing cell, which is placed at a boundary between the first block and the second block.

19. The integrated circuit of claim 18, wherein the first finishing cell has a structure terminating a first configuration of the first function cell array; and wherein the second finishing cell has a transitional structure between the first configuration and a second configuration of the second function cell array.

20. The integrated circuit of claim 18, wherein the first finishing cell and the second finishing cell are respectively placed at edges of the first block extending in parallel with a first direction.

21.-22. (canceled)
